(19) United States
(12) Patent Application Publication
(10) Pub. No.: US 2004/0150519 A1
(43) Pub. Date: Aug. 5, 2004

(54) System and method for monitoring having an embedded device

(76) Inventors: Iftikhar Husain, Prather, CA (US); Jeremy Cromwell, Fresno, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/356,646

(22) Filed: Jan. 31, 2003

(51) Int. Cl. G08B 29/00

(52) U.S. Cl. 340/506; 340/531; 340/870.01

(57) ABSTRACT

The present invention provides systems, methods, and computer program products for use in monitoring, and/or surveillance applications. Generally, systems provided include embedded devices with integrated sensors, manager software capable of supporting the particular sensors and embedded devices used, and a hierarchical database structure for storage and retrieval of continuous or event-based data. Preferred embedded devices advantageously include integrated audio, video, and wireless technology to provide an array of sensory detection, analysis, and interactive controls. Preferred database structures advantageously incorporate a secure archiving scheme for retrieval and/or analysis in multiple formats.

### FIELD OF THE INVENTION

Systems and methods according to the present invention are generally directed to event measurement, response, network monitoring and control systems, such as surveillance systems, remote environmental-monitoring systems, communication networks or control systems and medical monitoring systems, having an embedded device with a database system.

### BACKGROUND OF THE INVENTION

Monitoring and surveillance systems are presently focused on closed-circuit television and Internet-based monitoring via web cams. The state of the art systems in general consist of function specific systems—such as a security system or a surveillance system—with cameras or a process control system. Generally, present systems require an operator in an operation center or control room to be alerted to make decisions at various levels. State of the art systems that employ logic based decision algorithm are limited to a particular device level and thus the decision tree is not global in nature. A simple decision algorithm requires a specific response for a specific event deployed in current state of the art systems. Present solutions therefore provide a limited set of decisions and responses available.

The state of the art event response/measurement systems are an amalgam of proprietary separate hardware centric devices that contain industry specific systems such as security systems, process control systems, medical monitoring systems and the like, mostly limited to monitoring of data. Present systems, therefore, do not scale well or adapt to various industries.

### SUMMARY OF THE INVENTION

The present invention integrates a variety of sensors and database systems under the control of a software manger to monitor and control a complete environment. In a first aspect, the present invention provides a monitoring system including a plurality of embedded devices, each configured to receive data from at least one sensor. The embedded devices are also configured to analyze said data and determine if an event occurred on a device level. Systems further include a software manager configured to communicate with said plurality of embedded devices and determine, on a system level, if an event occurred. The software manager is further configured to send a message to at least one of said plurality of embedded devices if said event occurred. In this manner, tasks or procedures are automatically performed in response to events.

In another aspect, the present invention provides a method for continuous or event-based monitoring. Data is received from a sensor associated with a first embedded device. A determination is made, based at least in part on said data, that an event has occurred. If the event occurred, a task or procedure is electronically chosen to be performed. In some cases, a plurality of tasks or procedures may be performed. The chosen task or procedure is then automatically performed.

In another aspect, the present invention provides a computer program product for use in conjunction with a computer system having at least one processor and a memory coupled to the processor, the computer program product comprising a computer readable storage medium and a computer program mechanism embedded therein. The computer program mechanism includes a program module that directs the computer to function in a specified manner, the program module includes instructions for receiving data from a plurality of embedded devices comprising sensors. Instructions are further included for determining if an event has occurred and implementing at least one procedure if said event has occurred.

In another aspect, the program module further includes instructions for accessing a record in an embedded device database hosted by one of said embedded devices and controlling access to said records in said embedded device database. A method for controlling access is provided including providing a first designation for records indicative of a read mode and a second designation for records indicating a write mode.

### BRIEF DESCRIPTION OF THE DRAWINGS

The present invention may be better understood, and its features and advantages made apparent to those skilled in the art by referencing the accompanying drawings.

FIG. 1 depicts a preferred monitoring system according to an embodiment of the present invention.

FIG. 2 depicts an exemplary hierarchical database structure according to an embodiment of the present invention.

FIG. 3 shows a monitoring system and communication paths according to an embodiment of the present invention.

FIG. 4 depicts a signal flow path in a system according to an embodiment of the present invention.

FIG. 5 is a state diagram of an access control scheme according to an embodiment of the present invention.

### DETAILED DESCRIPTION OF THE EMBODIMENTS

The present invention provides systems, methods, and computer program products for use in monitoring, and/or surveillance applications. Generally, systems provided include embedded devices with integrated sensors, manager software capable of supporting the particular sensors and embedded devices used, and a hierarchical database structure for storage and retrieval of continuous or event-based data. Preferred embedded devices advantageously include integrated audio, video, and wireless technology to provide an array of sensory detection, analysis, and interactive controls. Preferred database structures advantageously incorporate a secure archiving scheme for retrieval and/or analysis in multiple formats.

The present invention integrates a variety of sensors and database systems under the control of a software manger to monitor and control a complete environment. Accordingly, systems according to the present invention may implement simple and complex decision algorithms which require a set of response(s) for certain Boolean logic conditions (such as for example, for certain AND/OR or other Boolean logic conditions) under processor control at a device level and manager control at a system level. That is, decisions may be made at the level of a particular embedded device, or may be made at a system level with input from a plurality of embedded devices, as facilitated by the software manager. The decision tree's global nature under the present invention enables it to provide a set of analog or discrete control response(s) to specific analog or discrete event(s) on a logical level regardless of geographical or physical boundaries. Embodiments of the present invention include or consist of a highly integrated and scalable system customizable to many industries including security and surveillance markets, environmental monitoring, process control and medical monitoring to name a few.

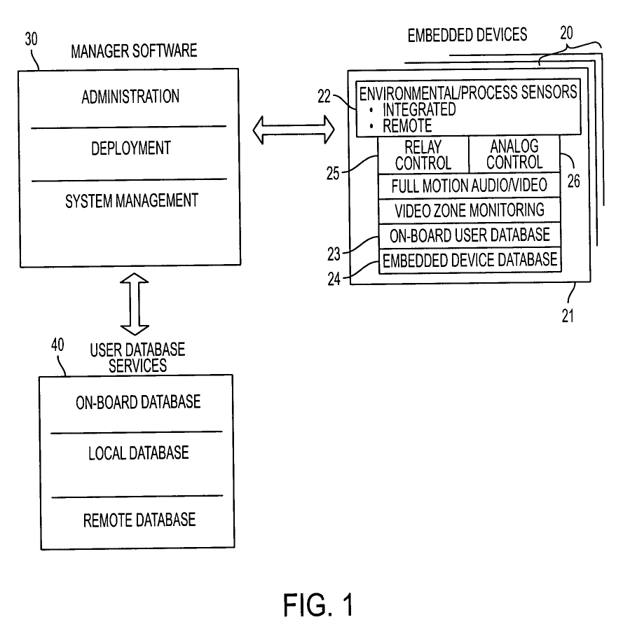

Accordingly, preferred system 10 is shown schematically in FIG. 1. System 10 comprises embedded devices 20 configured to acquire data about the environment or variable to be monitored, surveyed, or controlled. Embedded devices are described further below. Embedded devices 20 interface via manager software 30 with a hierarchical database structure 40. Manager software 30 preferably provides for the administration, deployment, and management of a plurality of embedded devices which may be co-located or located at any distance from one another—in separate rooms, buildings, countries, or continents, for example. Hierarchical database structure 40 provides for the efficient storage of data related to the monitored environment or variable. Accordingly, a plurality of databases are provided serving different long-term vs. short-term and high-quality vs. low-quality data storage on a continuous or event-based basis. Hierarchical database structure 40 generally provides for adequate data storage with a minimal memory requirement. Manager software 30 and hierarchical database structure 40 are described in further detail below.

Accordingly, systems according to the present invention include one or more embedded devices, such as embedded device 21 in FIG. 1. Generally, an embedded device has an input and an output. The input and output may be different physical structures, or be represented by a single physical structure or port. In general, the input of the embedded device receives control, configuration, or instructions, from manager software, as described further below. In some embodiments, an input of an embedded device is configured to receive data from a sensor. Embedded devices output data received from one or more sensors, and/or information regarding an event, as described further below. An embedded device may also be referred to herein as a WebMon™, and generally has some functionalities similar to that of a network gateway, as known in the art. In general, embedded devices include one or more sensors, such as sensor 22 in FIG. 1, either integrated into the device or in electronic communication with the device. Each embedded device generally may have any number of different sensors, in practical terms typically from 1 to 1,000 different sensors (though there is no fundamental limit on the number of sensors). An embedded device or system is some combination of computer hardware and software, either programmable or fixed in capability, that is specifically designed for a particular set of applications. Each sensor may monitor a different variable or environmental parameter, or a plurality of sensors may be of the same type. Sensors may be integrated into the embedded device, or may be remote sensors in electronic, optical, and/or acoustic communication, or capable of being brought into communication, with the embedded device. Examples of preferred sensors include digital video recorders or sensors, audio recorders or sensors, temperature sensors, pressure sensors, humidity sensor, optical sensors, light sensors, other environmental sensors, and the like. Generally, any sensor that monitors an environment, a condition, or a parameter (such as a valve sensor, pressure sensor, an actuator state, and the like) may be used as part of the embedded device. In preferred embodiments, sensors that may be included in one or more embedded devices include, but are not limited to CMOS (or other type) image sensors, 2-way audio communication sensors initiated by a browser, temperature sensors, air flow sensors, humidity sensors, carbon monoxide sensors, and fire and/or smoke detection, various spectroscopy sensors for hazardous gas and material detection, and nuclear radiation sensors. In some embodiments, medical monitoring is desired, and sensors may include, but are not limited to, blood pressure sensors, pulse rate sensors, EKG sensors, and EEG sensors.

Embedded devices may further comprise relay as well as analog controls, such as relay control 25 and analog control 26 in embedded device 21 of FIG. 1. Relay control is a discrete response to an event such as turning a device on or off while analog control is an analog response to an event such as controlling a valve in response to a flow rate, allowing the WebMon™ devices to control processes or other devices based on a certain set of events in a discrete manner, an analog manner, or through a combination of discrete and analog responses. Full Motion audio and video may be provided such that various events could be monitored and verified remotely based on archived data or live data. Further, video zone monitoring may advantageously be employed to detect a violation of preset rules and act. Examples of acting include, for example, alerting the administrator and simultaneously implement complex set of decisions. For example, if intrusion is detected in a predefined zone, certain doors may be locked and a dispatcher summoned or other responsive action taken. Other functionalities that may be provided by embedded devices in embodiments of the invention include, but are not limited to, e-mail or other electronic communication or reporting (for example, SNMP) of alarms or events, as described further below, a serial and/or USB configuration, automatic IP configuration (DHCP), manual IP addressing capability, HTTP browser support, and video pattern recognition.

Further, embedded devices contain an on-board database, such as on-board database 23 in FIG. 1. By on-board database herein is meant a database stored within the embedded device or hosted by the embedded device. The term on-board database is not intended to limit the physical location of the database or a memory device storing the data or database to a particular circuit board. Rather, the on-board database is integrated with, or in electronic communication with, the embedded device and generally stores data received from sensor 22, and/or other sensors associated with embedded device 21. The on-board database is part of the hierarchical database structure 40, also referred to as user database services herein, and will be described further below. Generally, memory is provided within the embedded device for use by the on-board database, and embedded database.

Accordingly, the on-board database generally stores an amount and type of data sufficient to determine that an event has occurred. Events, and examples of events, are described further below. Embedded devices advantageously further include sufficient processing power and software to analyze data generated by the sensors and to determine if an event has occurred. An event comprises or consists of a violation of predetermined simple or complex logic condition(s) as explained earlier. An event decision is made locally, either at an embedded device connected to a sensor and/or relayed to a manager (such as to a software manager) in case a system level decision is warranted. The term ‘Locally’ is used in a logical sense, that is, local to a system, but a system may be confined to a building or traverse countries or continents. Accordingly, a local decision is made as to whether an event has occurred. That is, system 10 may decide an event has occurred based on data from one or more embedded devices.

Embedded devices may further contain an embedded device database, such as embedded device database 24 in FIG. 1. Embedded device database 24 stores internal parameters and/or configuration values for embedded device 21. Examples of internal parameters and/or configuration values include user settings, preferences, hardware options, and the like.

Accordingly, embedded database 24 is preferably an internal database. In a preferred embodiment, embedded device database 24 stores packages containing records, which in turn contain fields. For example, one preferred package contains the configuration of email addresses that are used for email notification of events. The email package contains two records, one for each address. In each record, there is an email address field (which is text), a description field (also text), and a used field (which is Boolean).

Some packages contain only one record, such as the system information package that contains the system's IP address and description. Most packages have multiple records, such as network devices (used to keep information on devices that are monitored) which contains one record for each device.

The number of records in a package may be arbitrarily large, but in preferred embodiments, packages have between 1 and 100 records. In other embodiments, the number of records in a package may be any number or range or numbers between 1 and 100 records (for example between 10 and 50 records), and in other embodiments the number of records in a package may be any number or range of number of records between 1 and 10,000.

The number of fields in a record may be arbitrarily large, but in preferred embodiments, records have between 1 and 30 fields. Other embodiments may provide for a different number of fields, for example it may provide for records having between 1 and 8 fields, between 1 and 100 fields, or between 1 and 1000 fields.

A field contains one logical piece of information or data. For example, the field may include or contain a logical piece of information in the form of either a short piece of text or other symbolic information, in a preferred embodiment, 80 characters or less (or any other bit, byte, or character length), a number, an Internet Protocol (IP) address (which is a 32-bit number), or a Boolean value (True or False or “1” or “0”). Additional or alternative types may be added as needed.

In a preferred embodiment, each record contains a fixed number of fields in a fixed (predefined) order, although in some embodiments the number and order of fields may vary and/or the fields may be dynamically determined rather than fixed. Each field comprises data of a given type and a name or identifier associated with a given type. For example, description and location field names are associated with the type text, while trap target field names are associated with type IP addresses. Other types of data may include video, audio, temperature pressure, and the like. Computer software and computer program software products has been written to code a procedure and algorithm to translate each type of field data to text and back. (Of course, field data that is naturally in text form need not be translated.) Since each field advantageously has a name, and that name is associated with a type (the association may for example be by means of a look-up table or other relationship or data structure), the system can use that information to select the appropriate translation routine whenever text is required. This is most often used when configuration information is presented to the user, either when displaying status or during configuration.

For example, IP addresses, which are simply numbers, are translated into doffed-decimal notation (xxx.xxx.xxx.xxx). Accordingly, records may be manipulated as an asset of name-value pairs for the purposes of communication, storage and retrieval. That is, the particulars of packages, records, fields, types and names are described by way of an example of schemes resulting in the ability to manipulate data in the embedded device database as an asset. Other schemes may similarly be employed that result in the ability to manipulate and communicate data stored in the embedded device database with the various processes that may query the embedded device.

To control access to records stored in embedded device database 24, an access control scheme is provided to ensure that a record will not be altered by one process while being simultaneously read by another process (that is, an access control scheme is provided to ensure that data retrieved from embedded device database 24 is accurate). Several access control schemes are known in the art, and may be employed to control access to embedded device database 24, including the use of semaphores or flags, where the only task, user, or process that is able to access a record is the holder of a flag. However, in a preferred embodiment, an access control scheme is implemented that designates each record as being in one of three modes: Open (unused), read, or write. In other embodiments, a greater or fewer number of modes is provided, however the mode for read is distinguished from that of write. Further, a record preferably is also associated with the number of readers, writers and pending changes it has. The access control scheme requires that a record must be in the write mode before the data in its fields are modified. A record is preferably placed in read mode before data in its fields are read, however exceptions to this may exist, as described further below. Accordingly, an access control scheme is provided in preferred embodiments that places each record in embedded device database 24 in one of three states—open, read, or write. The operation of the preferred access control scheme is described further below.

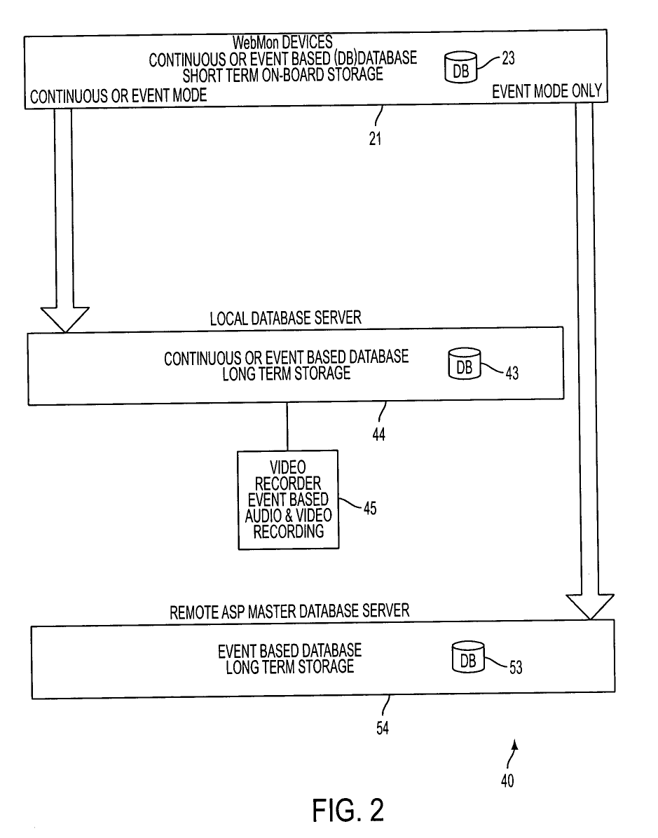

As described briefly above, referring to FIG. 1, embedded devices 20 are in communication with a hierarchical database structure, or user database services 40. Communication between embedded devices and the hierarchical database is mediated by manager software 30. FIG. 2 provides a schematic overview of a preferred embodiment of hierarchical database structure 40. Hierarchical database 40 is configured to provide distributed and redundant storage, as well as different levels and location of storage such that a trade-off between long- and short-term data storage and storage space and accessibility is achieved. In the embodiment shown in FIG. 2, three databases make up hierarchical database structure 40—on-board database 23, local database 43, and remote database 53. In a preferred embodiment, each database is hosted by a separate computer, or server, although in some embodiments one server may give access to a plurality of databases. Although only one of each database is shown in FIG. 2 , preferred systems will generally include a plurality of on-board databases (generally, but not exclusively, one on-board database per embedded device), and a plurality of local databases (generally, but not exclusively, one local database per monitored location or system). In some systems, a plurality of remote databases are provided, although it is generally desirable to limit the number of remote databases to save space and consolidate records.

Accordingly, on-board database 23 is provided associated with embedded device 21. That is, generally, at least one on-board database is provided for each embedded device in a system. As described above, the term on-board database here is used to describe the database's association with the embedded device, and is not intended to limit the physical configuration or design of the database. In one embodiment, the on-board data is stored as XML format and the local and/or remote database may be Oracle or SQL database. Other embodiments may store on-board data in formats different from XML or in extensions from XML and/or store the local and/or remote databases in databases different from Oracle or SQL databases. Generally, on-board databases are configured to receive data directly from sensors associated with the embedded device, such as sensor 22. That is, of the databases in the system, the on-board database (as opposed to local or remote database) will generally store the least compressed, highest-quality, most recent data, and will store a given piece of data for the shortest amount of time. The exact amount of compression (if any), quality, and timeframe considered recent will depend on the type of data being generated by a particular sensor, the quantity of data, rate of data generation, and rate of interest of the monitored environment or variable. For example, in monitoring a room for-surveillance or intrusion purposes, digital video may be captured at a maximum rate of 30 frames per second and stored in the on-board database as continuous or event based as configured by the user and limited by hardware storage media. Typical time frames for onboard data will depend on the type of data such as messages or audio/ video data. Also, if the data is event based or continuous. In a preferred embodiment, the on-board data will store 48 hours of 640×480 pixels resolution video with interlaced audio data in MPEG-4 or ITU/T H26L format and 60 hours of text message data prior to re-writing the on-board database memory. However, before any data is re-written on the disk media the system ensures that the data has been transferred to the local database. Generally, data stored by the on-board database is of sufficient quality or resolution for the system to determine that an event has occurred. Data may be stored in the on-board database on a continuous or event-based basis. By storing or receiving data on a continuous basis, herein is meant that a value for a variable is periodically and/or constantly sampled or otherwise generated. That is, generally, any data storage that is not taking place on an event-based basis is occurring on a continuous basis. By storing or receiving data on an event-based basis, herein is meant that data may be stored only when and/or after the system determines that an event has occurred. (Optionally, some buffering or temporary storage may be provided such that the data is captured and stored prior to an event occurring so that the data is available to be stored but only stored if the event occurs and discarded otherwise.) What constitutes an event is determined according to the type of variable or environment being monitored. Examples of events include, but are not limited to, detecting motion in a room, detecting a noise above or below a certain level, detecting a temperature above or below a certain value, or detecting a sharp or decreased rate of change of temperature, or detecting an abnormal variable value (valve position, power consumption, and the like). For example in case of a pipeline scenario, if a flow variation of fluid is detected at a point between San Francisco and Los Angeles due to a rupture in pipeline the flow change will be sensed by a sensor and if the valve control output is connected to the same embedded (WebMon™) device as the sense input then the embedded device will output a control message to shut the nearest valve(s) between the two locations and simultaneously alert the operators or management via email and pager. In addition the embedded device will alert the software manager in case the control is managed by another embedded (WebMon™) device in the system.

Local database 43 is provided to store data generated by sensors associated with embedded devices in a system, generally for a longer period of time than storage in on-board database 23. Further, data from a plurality of embedded devices is generally stored in local database 43. Accordingly, local database 43 is suitable for accessing to perform data analysis that takes data from a plurality of embedded devices into account. For example, local database 43 may receive data from embedded devices located in a plurality of positions in a room, or monitoring a plurality of variables associated with a system, or monitoring a plurality of locations throughout the world. The local database generally resides on a server, and various analysis capabilities are possible—including trending, generating histograms, change detection, various forms of linear and/or non-linear analysis, and the like. As with the on-board database above, local database 43 may store data on a continuous or event-based basis. In some embodiments, some data is stored on a continuous basis while other data is stored on an event-based basis. Local database 43 generally stores data over a longer period of time than on-board database 23. However, the amount of data and time the data is stored in a local database will depend on the amount, rate, and kind of data being generated by the sensors associated with the embedded devices. For example, video or audio records may be stored. In order to store a greater amount of data at local database 43, in some embodiments, data received from sensors in the system may be compressed in preparation for storage in local database 43. In preferred embodiments, the video data is compressed either via MPEG-4, or ITU/T H.26L compression schemes. The audio may be compressed via PCM (pulse code modulation) or ADPCM (Adaptive differential pulse code modulation) compression techniques. The message data is not compressed in preferred embodiments though such compression may occur in other embodiments. The decision to compress or not to compress may be a design decision based on various factors, such the expected size of the messages to be communicated and communication link bandwidth. Further, in preferred embodiments local database 43 is hosted by local database server 44 which is in electronic communication with back-up sensor 45, such as a video recorder in FIG. 2. Back-up sensor 45 generates data generally of the same kind or type as data generated by a sensor associated with an embedded device, but is designed to supplement that data when an event occurs. So, for example, if a digital video sensor generates data about a room, and the embedded device determines an event (such as an intrusion) has or has possibly occurred, video recorder 45 may begin capturing analog videotape data about the scene. This can be advantageous, for example, in a courtroom setting where only analog videotapes may be acceptable.

Finally, hierarchical database structure 40 contains or includes a remote database, such as remote database 53 in FIG. 2. Generally, remote database 53 provides long-term storage along the same time-frame as local database 43 above, or longer. Further data compression may occur in transferring data between local database 43 and remote database 53, in preferred embodiments. In some embodiments, remote database 53 may store data on a continuous- or event-based basis, however, remote database 53 preferably stores data only on an event-based basis. That is, remote database 53 stores only the data having a higher likelihood of being retrieved hours, days, months, or years after first being generated. Remote database 53 is preferably located separately from local database 43 to provide a back-up in the event local database 43 fails or is destroyed or damaged. Remote database 53 may further receive data from a plurality of local databases. In a preferred embodiment, remote databases receive event based messages and video and audio of 3 seconds of pre-event trigger data and 10 seconds of post event-trigger data. In one embodiment, the compression scheme utilized by video is either MPEG-4, or ITU/T H.26L. The messages are in the format of IBM's Websphere MQ, Oracle's AQ or TIBCO's Rendezvous formats in preferred embodiments, although other formats may be used.

As shown in FIG. 1, embedded devices 20 are generally in communication with the hierarchical database structure 40 through manager software 30. Program modules that make up manager software 30 may be located on any of the servers hosting databases, or other servers in communication with any of the above, or in a combination of locations. Manager software 30 provides of the administration, deployment, and configuring and system management of the monitoring system. Additionally, manager software 30 may provide tools for data analysis. Manager software 30 further provides functionality for reading sensors, detecting events, logging events, and communicating events.

Manager software consists of a (GUI) Graphical User Interface management software, to administer, configure, and manage embedded devices in a system. Further, the manager software receives events (when deployed) from all embedded devices in the system and makes decisions at system level and responds accordingly either by reporting via email, pager or asserting analog or discrete controls. Certain functionalities of manager software will be described further below in the context of communication within and operation of the monitoring systems of the present invention.

The Manager software is further capable of communicating with WebMon™ devices as well as third party proprietary devices through various methods as described further below.

In a preferred embodiment, Manager software communicates with embedded devices through SNMP (Simple Network Management Protocol) or HTTP (Hypertext Transfer Protocol) using secure connection by SSL (Secure Socket Layer) ensuring 128 bit encryption or higher.

In preferred embodiments, network security is provided within the system. Manager software's requests are authenticated by the embedded device (WebMon™) using SOAP (Simple Object Access Protocol) or SNMP version 3 protocol. The embedded devices can accept configuration requests only by the authorized Manager Software. The embedded device authenticates the Manager software based on the ID and the system specific information of the Manager Software. Other methods known in the art may be used to provide network security and/or authentication.

Manager software extends to two levels of customized support for third party support in a preferred embodiment. The levels are (a) Device level, and (b) Browser level.

In a preferred embodiment, Manager software provides support for extensibility and scalability to third party proprietary applications. Each embedded device is modeled as a separate COM component. Since each device is modeled as a COM component, third party application can provide extensions to this object or can replace this object with their own COM component. In this way it enables third party applications to use the capabilities of the WebMon™ Manager software and a more versatile, customized support to manage, monitor and configure different devices from one central point.

The Manager software preferably requires that a pre-defined set of interfaces also known as device extensions such as ActiveX controls must be implemented in order to communicate between the WebMon™ Manager and the embedded devices. These interfaces also require one or more property pages of the embedded devices in order to allow the WebMon™ Manager software to fully communicate with the embedded devices' preset configuration properties.

Browser level extensions are ActiveX controls responsible for monitoring overall functionality of various devices it administers. Like device extensions, this also should implement a pre-defined set of interfaces through WebMon™ Manager software.

Through the use of an open platform consisting entirely of COM interfaces and ActiveX, the API (Application Programmers Interface) can be made available to third parties for developing their own custom browser applications and extensions.

Third Party applications cannot directly communicate with the WebMon™ device unless the device level extensions to the existing interfaces implemented by the object are developed for the third party devices.

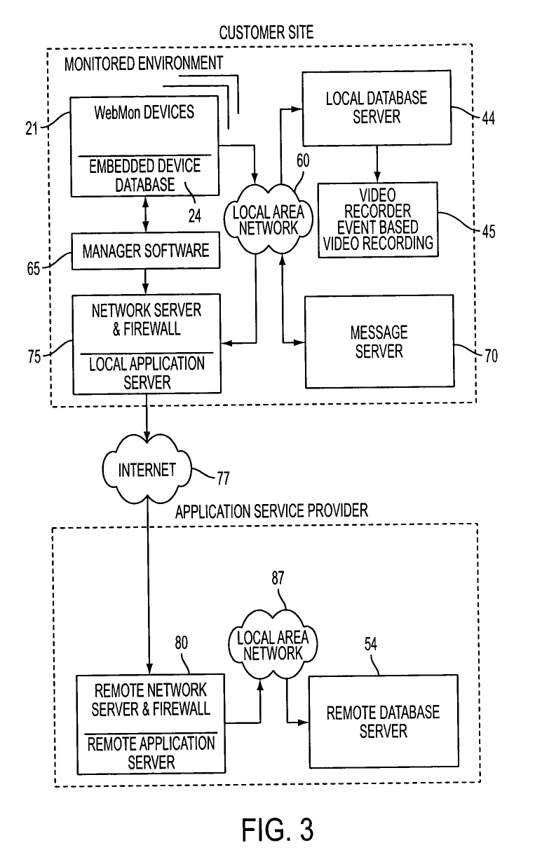

Systems of the present invention can be configured in a variety of ways. In some embodiments, access is provided through a browser, directly to an embedded device. In such embodiments, only data generated by sensors associated with that embedded device may be accessible. FIG. 3 depicts a schematic overview of a system according to an embodiment of the present invention as it operates in a customer site/ remote provider site situation. Embedded device 21 with embedded device database 24, local database 44, optionally associated with back-up sensor 45, message server 70, and network server and optional firewall and local application server 75, are all in electronic communication with or capable of being in electronic communication with one another over network 60. Further, manager software 65 is provided to interface with embedded devices within the system, including embedded device 21. Manager software 65 interfaces with the embedded devices and local application server 75 to control and administer devices in the system, as well as to determine whether an event has occurred and to select a task, procedure or other action to perform if an event has occurred. By capable of electronic communication, herein is meant that the server or device may not necessarily be in constant communication with network 60 in some embodiments where connection to network 60, and/or communication, may be intermittent. Communication in the form or optical communication, radio-frequency communication, and other forms of communication associated with computer and communication networks and devices and systems associated with such systems are also included in the class of electronic communication. In a preferred embodiment, network 60 is a local area network, but in some embodiments network 60 may be a wide-area network, Internet, or other networking system. Further, network interfaces for communicating over network 60 may be any of a variety of protocols, including wireless—for example embedded devices may support wired Ethernet 10/100base T in some embodiments, PCMCIA type I, II, and/or III slots are provided for a PC card and communication according to IEEE802.11a or b and/or Bluetooth, and FSK (Frequency Shift Key) modulation dial-in/out modem, RS-232/485 as a backup communication interface and in some embodiments a combination of networking protocols are used such as TL1 (Transaction level 1) over TCP/IP. Although only one embedded devices is shown in FIG. 3 for ease of illustration, it is to be understood that a plurality of embedded device may be present and in communication with network 60.

Network server, or local application server 75, optionally also including a security firewall or other security means is in electronic communication, or capable of electronic communication with master application server 80 over network 77. Master application 80 is, in a preferred embodiment, physically separate from local application server 75 and may be provided, for example, by a service provider and may access a plurality of local application servers. In a preferred embodiment, network 77 is the Internet, but may be any other network, including a local area network, that supports communication between the local application server and the master application server. Master application server 80 also optionally includes a firewall. Master application server 80 is in electronic communication with remote database server 54 via network 87. Master database server 54 hosts remote database 53.

In a preferred embodiment, embedded devices, such as device 21, local database server 44, optional back-up sensor 45, message server 70, local application server 75 and network 60 are located at a customer, or user, site and are administered by a first entity (customer, user, and the like). Master application server 80, network 87, and remote server 54 may be administered independently from the systems at the customer site and are administered and located at facilities operated by an application service provider. Communication between the local application server and master application server is facilitated by network 77.

Accordingly, in a preferred embodiment continuous and/or event-based data flows from embedded device 21 to local database server 44 via network 60 and to master database server via network 77, and optionally also network 87. In a preferred embodiment, the continuous and/or event-based data is archived in local database 43, hosted by database server 44 and only event-based data is forwarded to remote master database server 54, to be archived in remote database 53.

Message server 70 provides messaging service between embedded devices and application server , or network server 75 through a message broker. That is message server 70 provides the messaging service in network 60. The messaging broker, generally provided in software on message server 70, converts the information sent by embedded devices into message that can be interpreted by, or invoke procedures at, their destination, such as the application server. In a preferred embodiment, the messaging broker converts SNMP (Simple Network Management Protocol) traps sent by embedded devices into messages understood by application server 75. In a preferred embodiment, the Application server understands messages in IBM's Websphere MQ or Oracle's AQ or TIBCO's Rendezvous formats. The message conversion is undertaken by the Message Broker which converts SNMP traps to either one of the above mentioned message formats. In a preferred embodiment, and unlike known traditional three-tier database structures, where messages are assigned a priority level based on message type, all messages are assigned a same priority, determined by the time at which the messages are received at the destination. The data (video, audio) is cached on the on-board database for a predetermined capacity and transferred to the local and remote database as the local data cache capacity is exhausted minimizing network delay, providing redundancy and providing data unaffected, or comparatively less affected than other schemes, by communication link noise and failures. The User Database System provides multi-layer data redundancy. The three-tier database is a message communication methodology between client and a database through a middle-ware and should not be confused with the multi-layer database which refers to database redundancy.

After submitting a message to application server 75, in a preferred embodiment, the message broker waits for a response of success or failure of remote or local database updates. If the update is successful, message server 70 tags the ID of the message as successful. If a failure is reported, an e-mail or other notification (pager, telephone call, alarm, or the like) is generated to alert appropriate database support of a possible database update failure due to possible link, hardware or software failure and may require reconciliation once the offending condition has been remedied. The reconciliation process involves comparison of database depending on the source and destination of the database hierarchy. It may be between the on-board and the local database or the local and the remote database. Alternatively or in addition, an embedded device may notify other devices or sensors about an event via SNMP traps, or other network communication. E-mails or telephone numbers, and the like for notifying personnel are one example of data that may be contained in an embedded database, described above, and further below. All messages that need reconciliation between message server 70 and application server 75 are queued and serviced on a first-in, first-out (FIFO) basis, in a preferred embodiment. In other embodiments, messages needing reconciliation are dealt with using other procedures as known in the art. After any necessary reconciliation, messages are successfully processed by the database and later purged from message server 70. In preferred embodiments, unresolved problems are addressed by local or remote customer support and re-sent to the appropriate database.

As described briefly above, access to embedded database 24 is governed by an access control scheme implemented by a portion of the embedded software implements the access control scheme. Various processes may attempt to access records in the embedded database—such as e-mail addresses or other contact information to notify administrators or other personnel when an event is detected, or at other times as appropriate. As described above, records in the embedded device database, in a preferred embodiment are in one of three states—open, read, or write. In other embodiments, there may be more or fewer modes, and the modes may have different designations, however the read mode is distinguished from a write mode. Further, records keep track of the number of processes or users reading, or writing to, the record, in preferred embodiments.

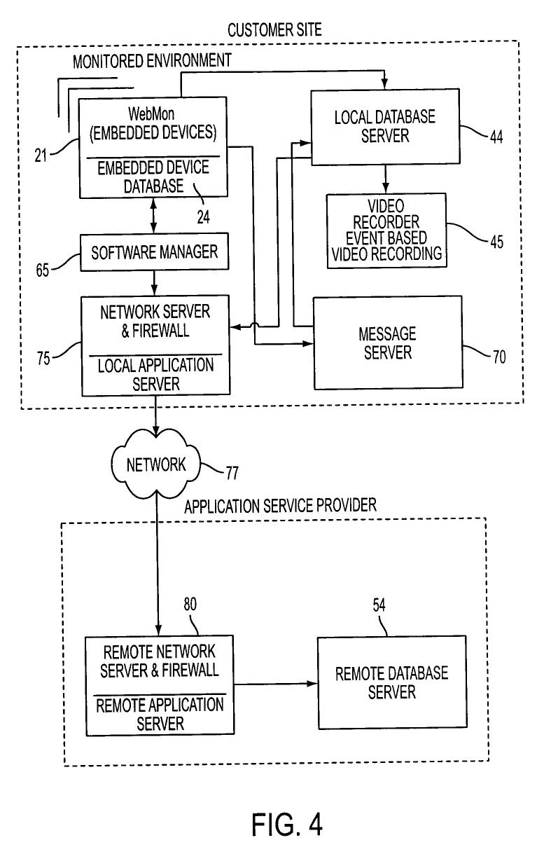

FIG. 4 is an overview diagram of a system according to an embodiment of the present invention, generally showing signal flows within the system. FIG. 4 does not depict network 60 or 87 for clarity and ease of illustration. In some embodiments of the present invention, the direct connections shown in FIG. 4 are utilized to pass communication and a network layer may not be needed, per se. In FIG. 4, Embedded devices, such as embedded device 21 having embedded device database 24, sends information to message server 70, and interacts with software manager 65. Embedded devices further communicate with local database server 44. Local database server 44 is capable of communication with local application server 75, and optional back-up sensor 45. Message server 70 receives data, signals or messages from embedded devices in the system and sends messages or signals to local database server 44. Software manager 65 communicates with embedded devices and local application server 75 to facilitate event determination, and to select and perform actions, tasks, or procedures based on events. Local application server 75 is in communication with remote server 80 through network 77, as described above. Network server 80 is also in communication with remote database server 54, as described above.

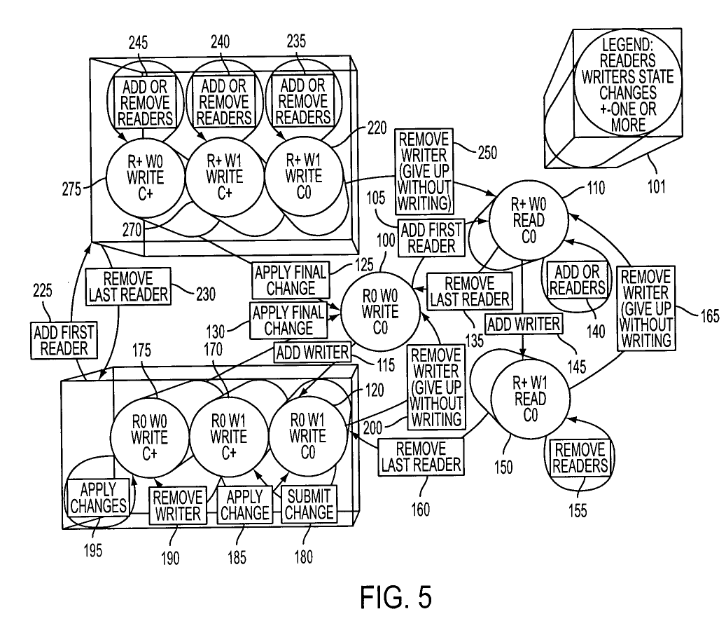

FIG. 5 is a schematic representation of a state diagram depicting the operation of an access control scheme according to a preferred embodiment of the present invention. Each circle represents a state of a record, showing the mode designation in the center, number of readers (R0 for no readers, R1 for one reader, and R+ for one or more readers), number of writers (W0 for no writers, W1 for one writer, and W+ for one or more writers), and number of changes queued to be made to the record (C0 for no changes and C+ for one or more changes), as shown by legend 101 in FIG. 5. The state diagram in FIG. 5 is intended to illustrate the operation of an access control system to embedded database 24, and is not intended to limit the structure or functionality of the access control system or database. In a preferred embodiment in open mode 100, adding a first reader, step 105, places the record in read mode, in state 110 having at least one reader, no writers, and no changes queued. The record returns to open mode and state 100 when all readers are removed (step 135). In an analogous manner, from open mode 100, adding a first writer, step 115, transitions the record to write mode and state 120, having no readers, one writer, and no changes queued. A record will return to open mode, and state 100 when all writers are removed and all changes applied (step 130).

In read mode a record may be read by multiple tasks simultaneously, and changes cannot be queued or applied. Further, if a record is in state 110, read mode with no writers, readers can be added or removed, generally indefinitely (step 140). Once a writer is added, step 145, the record remains in read mode but transitions to state 150, having one writer. No additional readers may be added. Readers are removed as the record is read (step 155). Should the writer decide to give up without writing (step 165), the record transitions to state 110, and remains in read mode. Once all readers are removed (step 160), the record transitions to write mode and state 120.

In write mode, a record can be written to by only one task. Additional writers may not be added. However, readers can be added and removed, generally indefinitely. If no readers are added, a record transitions among states 120, 170, and 175 as shown in FIG. 5. When write mode is entered, a record is in state 120 having no writers, one reader, and no pending changes. Reading (by the writer) can be done safely only before the change is queued. The writer submits a change (step 180), and the record transitions to state 170. If the change is applied (step 185), the record transitions back to state 120. If the writer is removed (step 190), the record transitions to state 175, having no writers, and changes are applied (step 195), until the final change is applied (step 130), transitioning the record to open mode and state 100. Further, if the record enters write mode in state 120, and the writer gives up without writing (step 200), the record is transitioned to open mode and state 100. As described above, readers can be added and removed while the record is in write mode. Accordingly, states 120, 170, and 175 may transition back and forth to states 220, 270, and 275, respectively, in steps 225 and 230. The diagram in FIG. 5 omits the state transition arrows between states 120 and 220, 170 and 270, and 175 and 275 for ease of illustration. In states 220, 270 and 275, the record remains in write mode and readers can be added and/or removed in steps 235, 240, and 245. If the record is in write mode in state 220, and the writer is removed, that is the writer gives up without writing (step 250), the record enters read mode and state 110. The existence of readers in 240 and 245 prevent the transition to the open state 100.

The state diagram in FIG. 5 and the above description of the state diagram are provided for exemplary purposes only to illustrate an embodiment of the invention. A variety of modifications may be made to the particular state diagram and procedure used for an access control scheme while remaining within the scope of the present invention. Access control schemes according to the present invention provide a write mode when a writer is added that is distinguished from a read mode having readers accessing the record. Further, access control schemes according to the present invention provide a two-step process for changing a record. A first step is adding a writer to the record, and a second step is queuing a change. Accordingly, in a preferred embodiment creating a reader or writer object is performed according to a function call which accesses the database. Both reader and writer inherit from a common holder object. On construction, the record holder object attempts to place the requested record into a given mode. The two-step process is evidenced as the holder first attempts to add a user (reader or writer) to the record, then checks to see if the record is now in the given mode. Normally, the object will cause the task to steep until the record can be placed into the mode. However, in some embodiments, for critical tasks, the holder can be told to give up rather than sleep and retry. It is then incumbent on the task to check if the holder was able to successfully hold the record. In preferred embodiments, the record holder contains a pointer to the held record, which can be accessed directly. On destruction, the record holder removes the user.

Accordingly, in preferred embodiments, if a task is modifying a record, no other task is allowed access. Tasks that are denied immediate access can either wait or go on to other duties. If a task is simply viewing a record, other tasks are allowed to view it as well.

Systems and methods according to the present invention find use in a variety of applications. Generally, the systems provide monitoring, reporting of events, and the capability to analyze stored data about the environment or variable monitored. Accordingly, data can be generated and gathered by a plurality of sensors distributed around a room, building, piece of equipment, laboratory, worldwide, or even in outer-space or between objects in space. Events, defined by a particular variable level or a particular variable change over time, or a combination of sensor criteria, can be detected and reported. Reporting an event can include notifying key personnel, as well as notifying other devices (alarms, other sensors), to activate. Accordingly, the present invention finds use in surveillance systems, intrusion detection, environmental monitoring, equipment monitoring, and medical monitoring, as well as providing advantages for remote control. For example, the embedded device (WebMon™) could be used to transmit brain wave data (or data derived from brain waves) wirelessly or through a wired sensor to the local database from a subject during some activity (or apparent non-activity), such as for example from a human subject during sleep apnea studies for further evaluation. It may also be used to collect data from animal subjects during some activity. Another application may be in the security and monitoring arena where the embedded device senses a intrusion via motion detection sensors and alerts the responsible party or parties (three different individuals or entities in one embodiment, if desired) via email or pager or by any other means; the archiving process of the event data is initiated on the User Database and the relay controls are activated by the system to secure the locks to a specific area. The responsible party once alerted could connect to the embedded device (WebMon™) via the Internet or other communication means and verify the intrusion and may verbally query the intruder's identity or other information from the comfort of his/her home, if desired.

The invention may advantageously implement the methods and procedures described herein on a general purpose or special purpose computing device, such as a device having a processor for executing computer program code instructions and a memory coupled to the processor for storing data and/or commands. It will be appreciated the computing device may be a single computer or a plurality of networked computers and that the several procedures associated with implementing the methods and procedures described herein may be implemented on one or a plurality of computing devices. In some aspects of the invention, conventional personal computers (such as personal computers or PC's) and server computers are utilized. Information may also or alternatively be communicated to a variety of information appliances having processor and memory and communication capabilities. For example, various hand-held and/or mobile devices such as mobile telephones, personal data assistants (PDA) or the like may be used. In some embodiments the inventive procedures and methods are implemented on standard server-client network infrastructures with the inventive features added on top of such infrastructure or compatible therewith.

The foregoing descriptions of specific embodiments and best mode of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A monitoring system comprising:
a plurality of embedded devices, each configured to receive data from at least one sensor, said embedded devices further configured to analyze said data and determine if an event occurred on a device level; and
a software manager configured to communicate with said plurality of embedded devices and determine, on a system level, if an event occurred, said software manager further configured to send a message to at least one of said plurality of embedded devices if said event occurred.

2. A system according to claim 1, wherein said determination that an event occurred is based on data received from a first embedded device of said plurality of embedded devices, and said message is sent to a second embedded device of said plurality of embedded devices.

3. A system according to claim 1, said system further comprising
a hierarchical database structure in communication with said embedded devices and said manager software, said hierarchical database structure storing data generated by said sensors.

4. A system according to claim 1, wherein at least one of said embedded devices comprises a relay control.

5. A system according to claim 1, wherein at least one of said embedded devices comprises an analog control.

6. A system according to claim 1, wherein at least one of said embedded devices comprises a relay and an analog control.

7. A system according to claim 4, wherein said message sent by said manager software results in said at least one of said embedded devices generating a relay control message.

8. A system according to claim 5, wherein said message sent by said manager software results in said at least one of said embedded devices generating an analog control message.

9. A system according to claim 6, wherein said message sent by said manager software results in said at least one of said embedded devices generating an analog and a relay control message.

10. A system according to claim 1, further comprising
a message server capable of electronic communication with said embedded devices; and
an application server capable of electronic communication with said message server.

11. A system according to claim 1, wherein said plurality of embedded devices each further comprise an on-board database.

12. A system according to claim 11, wherein said on-board database operates to store continuous data from said sensor.

13. A system according to claim 11, wherein said on-board database operates to store event-based data from said sensor.

14. A system according to claim 11, wherein said on-board database maintains high quality video data.

15. A system according to claim 11, wherein said on-board database maintains high-quality audio data.

16. A system according to claim 3, wherein said hierarchical database structure comprises a local database server capable of electronic communication with said embedded device, said message server, and said application server.

17. A system according to claim 16, wherein said local database server stores archived data from said sensor.

18. A system according to claim 17, wherein said archived data and said manager software are configured to facilitate data analysis.

19. A system according to claim 18, wherein said data analysis comprises trending.

20. A system according to claim 18, wherein said data analysis comprises generating a histogram.

21. A system according to claim 1, wherein said embedded device comprises a plurality of sensors.

22. A system according to claim 21, wherein said plurality of sensors comprise a video sensor and an audio sensor.

23. A system according to claim 10, wherein said messaging server comprises a message broker configured to convert data sent by said embedded device into messages for said application server.

25. A system according to claim 23, wherein said data sent by said embedded device comprises an SNMP trap.

26. A system according to claim 3, wherein said hierarchical database structure comprises a remote database server capable of electronic communication with said application server.

27. A system according to claim 26, wherein said remote database stores event-based data from said sensor.

28. A system according to claim 16, further comprising a video recorder in electronic communication with said local database server.

29. A system according to claim 1, wherein each of said embedded devices further comprise an embedded device database.

30. A system according to claim 29, wherein said embedded device databases store a plurality of records, and wherein each record is associated with a first mode if the record is going to be modified and a second mode if the record is able to be read.

31. A system according to claim 30, wherein said embedded device database further stores a number of readers and a number of writers associated with each record.

32. A monitoring system according to claim 1, wherein each of said embedded devices further comprise an embedded device database for storing configuration information, and wherein an access control scheme governs access to said embedded device database.

33. A monitoring system according to claim 32 wherein said embedded device database stores records, and wherein said access control scheme provides a first designation for records indicating a read mode and a second designation for records indicating a write mode.

34. A method for continuous or event-based monitoring comprising:
receiving data from a sensor associated with a first embedded device;
determining, based at least in part on said data, that an event has occurred;
if said event occurred, electronically determining at least one task to perform; and
automatically performing said task.

35. A method according to claim 34, wherein said at least one task comprises sending an electronic mail message.

36. A method according to claim 35, wherein said at least one task comprises sending a page.

37. A method according to claim 34, wherein said at least one task comprises controlling a device.

38. A method according to claim 37, wherein said event comprises a change in flow rate and said device comprises a valve.

39. A method according to claim 38, wherein said task comprises sending a message to a second embedded device in communication with said valve.

40. A method according to claim 34, said method further comprising
storing said data in an on-board short-term database;
transferring some of said data to a local database server; and
sending event-based data to an offsite long-term database.

41. A method according to claim 34, further comprising:
receiving second data from an analog video recorder in response to an event.

42. A method according to claim 34, further comprising:
receiving data from a plurality of embedded devices.

43. A method according to claim 40, wherein said transferring some of said data to a local database server comprises compressing said data.

44. A method according to claim 43, further comprising analyzing said data stored in said local database server.

45. A method according to claim 44, wherein said analyzing comprises generating a histogram.

46. A computer program product for use in conjunction with a computer system having at least one processor and a memory coupled to the processor, the computer program product comprising a computer readable storage medium and a computer program mechanism embedded therein, the computer program mechanism, comprising:
a program module that directs the computer to function in a specified manner, the program module including instructions for:
receiving data from a plurality of embedded devices comprising sensors;
determining if an event has occurred; and
implementing at least one procedure if said event has occurred.

47. A computer program product according to claim 46, wherein said implementing procedures comprises sending an electronic mail message.

48. A computer program product according to claim 46, wherein said implementing procedures comprises initiating a telephone call.

49. A computer program product according to claim 46, wherein said implementing procedures comprises sounding an alarm.

50. A computer program product according to claim 46, wherein said implementing procedures comprises activating a back-up sensor.

51. A computer program product according to claim 46, wherein said implementing procedures comprises transmitting data indicating the occurrence of said event to at least one device.

52. A computer program product according to claim 46, wherein said implementing notification procedures comprises accessing a record in an embedded device database hosted by one of said embedded devices.

53. A computer program product according to claim 52, wherein said program module further includes instructions for:
controlling access to said records in said embedded device database.

54. A computer program product according to claim 53, wherein said controlling access comprises providing a first designation for records indicate a read more and a second designation for records indicating a write mode.

55. A computer program product according to claim 54, wherein said controlling access further comprises receiving a request to write a record and, responsive to said request:
a) attempting to add a writer to said record; and if said attempt to add a writer is successful; and
b) queuing a change for said record.

56. An embedded device comprising:
an input configured to receive data from at least one external sensor;
a processor receiving said sensor data and performing an analysis based at least in part on said sensor data to determine if an event occurred on a device level; and
an output adapted for communication with an external manager for communicating said event occurrence determination to said external manager.

57. A device according to claim 56, wherein said input and said output are adapted for communication with a hierarchical database structure, said hierarchical database structure storing data generated by said sensor.

58. A device according to claim 56, wherein said embedded device comprises a relay control.

59. A device according to claim 56, wherein said embedded device comprises an analog control.

60. A device according to claim 56, wherein said embedded device comprises a relay control and an analog control.

61. A device according to claim 56, wherein said embedded device comprises an on-board database.

62 A device according to claim 61, wherein said on-board database operates to store continuous data from said sensor.

63 A device according to claim 61, wherein said on-board database operates to store event-based data from said sensor.

64. A device according to claim 56, wherein said data analysis comprises trending.

65. A device according to claim 56, wherein said data analysis comprises generating a histogram.

66. A device according to claim 56, wherein said embedded device comprises a plurality of sensors.

67. A device according to claim 66, wherein said plurality of sensors comprise a video sensor and an audio sensor.

68. A device according to claim 56, wherein said embedded device further comprises an embedded device database.

69. A device according to claim 68, wherein said embedded device database stores a plurality of records, and wherein each record is associated with a first mode if the record is going to be modified and a second mode if the record is able to be read.
